(19) United States
(12) Patent Application Publication
(10) Pub. No.: US 2020/0184420 A1
(43) Pub. Date: Jun. 11, 2020

(54) SYSTEMS AND METHODS FOR CLOUD BASED AUTOMATED COMPLIANCE

(71) Applicant: FOCUS451, Inc., Sunnyvale, CA (US)

(72) Inventor: Mandar DANGE, Sunnyvale, CA (US)

(21) Appl. No.: 16/711,324

(22) Filed: Dec. 11, 2019

Related U.S. Application Data
(60) Provisional application No. 62/778,117, filed on Dec. 11, 2018.
(60) Provisional application No. 62/778,146, filed on Dec. 11, 2018.
(60) Provisional application No. 62/778,176, filed on Dec. 11, 2018.

(51) Int. Cl. G06Q 10/10; G06F 16/93

(52) U.S. Cl. CPC G06Q 10/10; G06F 16/93

(57) ABSTRACT

According to one aspect, a system comprising: one or more servers coupled with a plurality of storage devices configured to store a plurality of compliance templates for franchisors, franchisees, and small business owners, and a plurality of libraries created by one or more franchisors, one or more franchisees, and one or more small business owners; a plurality of franchisor applications, franchisee applications, and small business applications, each application comprising a User Interface (U/I) and a template creation wizard; a plurality of local devices configured to store the plurality of franchisor applications, franchisee applications, and small business applications comprising one or more processors configured to run the applications and automatically generate custom templates for each employee associated with each franchisee and small business owner based on the department, stage and location of the employee; and a communication network coupled with the one or more servers, plurality of franchisor applications, franchisee applications, and small business applications and one or more storage devices and configured to allow the plurality of franchisor applications, franchisee applications, and small business applications to store the customized templates in one or more libraries associated with each of the franchisors, franchisees and small business owners.

### CROSS-REFERENCES TO RELATED APPLICATIONS

This application claims the benefit under 35 U.S.C. § 119(e) of the filing date of U.S. Provisional Patent Application No. 62/778,117, filed on Dec. 11, 2018, entitled “SYSTEMS AND METHODS FOR CLOUD BASED AUTOMATED COMPLIANCE,” and U.S. Provisional Patent Application No. 62/778,146, filed on Dec. 11, 2018, entitled “SYSTEMS AND METHODS FOR AUTOMATIC COMPLIANCE TEMPLATE CREATION IN A CLOUD BASED AUTOMATED COMPLIANCE SYSTEM,” and U.S. Provisional Patent Application No. 62/778,176, filed on Dec. 11, 2018, entitled “SYSTEMS AND METHODS FOR AUTOMATIC COMPLIANCE ENFORCEMENT IN A CLOUD BASED AUTOMATED COMPLIANCE SYSTEM.” The disclosures of the above applications are incorporated by reference in their entireties as a part of this document.

### BACKGROUND

### 1. Technical Field

The embodiments described herein are related to cloud based multi-client compliance management systems and more particularly to systems and methods for automating compliance tracking through template driven compliance libraries.

### 2. Related Art

Businesses are responsible for ensuring that they and their employees are in full compliance with all applicable laws and regulations. Unfortunately, there are no tools available to, e.g., a small business to help them manage compliance cycles, documentation, and certifications. This obligation can be compounded for Franchisees, with multiple locations, as well as Franchisors, who may have joint liability with their Franchisees with respect to many of these issues. Many Franchisees and small business owners have no idea about the need to manage compliance for each employee as well as for the business.

Moreover, many franchise requirements, such as the code of conduct, had to be refreshed every year for every employee. And often updated or new compliance requirement are promulgated. Do to the lack of tools and automation, it can be extremely difficult to keep track of all the requirements, cycles, updates, etc. These issues often become more pronounced the more locations that are involved.

Conventionally, e.g., the Franchisee will use checklists, spread sheets, intelligent scan and upload solutions, etc., but only through time-consuming physical internal audits can any missing items be uncovered. And by the time any such items are discovered, it is often too late. Conventional human resource (HRIS) platforms are of little help.

Securely storing physical paperwork with appropriate access is another deficiency of conventional systems and approaches. The penalty for non-compliance can negatively impact the business credibility, not to mention the financial impact.

### SUMMARY

Systems and methods for cloud based compliance management are described herein.

According to one aspect, a system comprising: one or more servers coupled with a plurality of storage devices configured to store a plurality of compliance templates for franchisors, franchisees, and small business owners, and a plurality of libraries created by one or more franchisors, one or more franchisees, and one or more small business owners; a plurality of franchisor applications, franchisee applications, and small business applications, each application comprising a User Interface (U/I) and a template creation wizard; a plurality of local devices configured to store the plurality of franchisor applications, franchisee applications, and small business applications comprising one or more processors configured to run the applications and automatically generate custom templates for each employee associated with each franchisee and small business owner based on the department, stage and location of the employee; and a communication network coupled with the one or more servers, plurality of franchisor applications, franchisee applications, and small business applications and one or more storage devices and configured to allow the plurality of franchisor applications, franchisee applications, and small business applications to store the customized templates in one or more libraries associated with each of the franchisors, franchisees and small business owners.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example cloud based compliance system configured in accordance with one embodiment; and

FIG. 2 is a diagram illustrating an example processing system that can be included in the system of FIG. 1 in accordance with one example embodiment.

### DETAILED DESCRIPTION

The systems and methods described herein are the product of months of effort working with franchisees, franchisers and legal experts in the field. The result, as described herein is a simple, easy-to-use, lightweight, secure cloud-based tool. “Auto Enforcement” as an important feature. The tools described are affordable for a small business owner as well as dynamic enough to “fast-track” existing employees while allowing for multi-location growth.

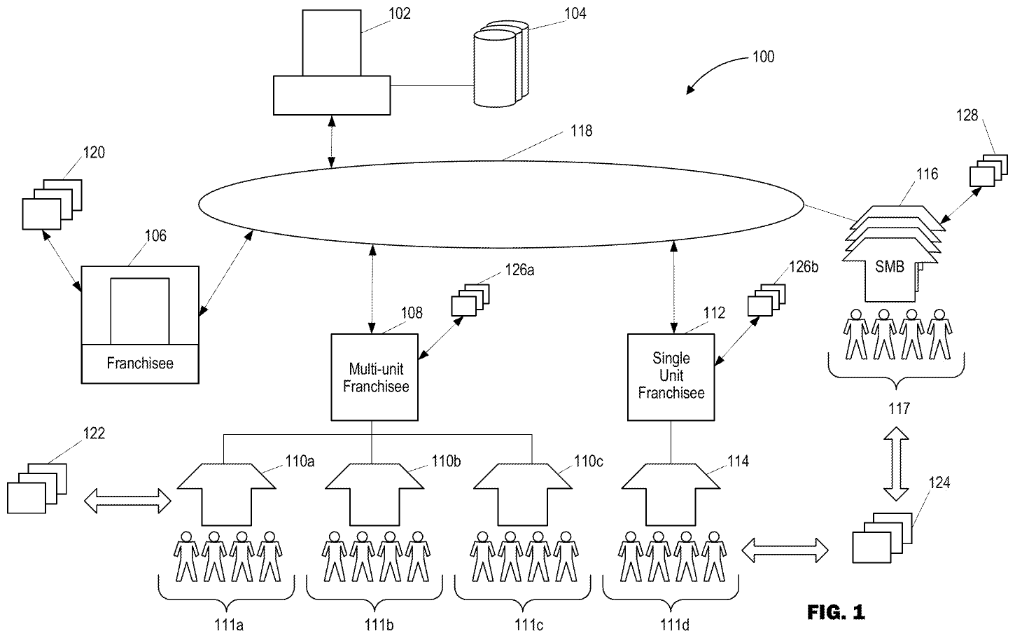

FIG. 1 is a diagram illustrating a system 100 for cloud based compliance management in accordance with one example embodiment. As can be seen, system 100 comprises one or more servers 102 coupled with a plurality of storage devices 104. Storage devices can be configured to store and provide access via server 102 a template library that allows an enterprise or business owner to quickly configure and automate their compliance system. The template libraries are described in more detail below. It will be understood that server(s) 102 and storage device(s) 104 can be co-located or can be remotely located relative to each other.

One or more franchisors 106 can be interfaces via communication network 118 with server(s) 102 in order to access the libraries and compliance modules as well as to store their data. One or more multi-unit franchisees 108 and single unit franchisees 112, associated with the one or more franchisors can also be interfaced both with franchisor 106 and storage devices 104. A plurality of Small Business (SMB) locations can also be interfaced with storage devices 104.

Multi-unit franchisee 108 is associated with a plurality of locations 110a-c, while single unit franchisee 112 is associated with a single location 114. Each location 110a-b, location 114, and SMB 116 is associated with a plurality of employees 111a-d and 117 respectively.

It will be understood that franchisor 106, franchisees 108 and 112, locations 110a-c and 114, SMB's 116, and employees 111a-d and 117 can all interface with communication network 118, server 102/storage devices 104, and each other as well as access he required software and applications, some of which are described herein, via the appropriate hardware and software as described below. Each of franchisor 106, franchisees 108 and 112, locations 110a-c and 114, SMB's 116, and employees 111a-d and 117 can access applications 120, 126a and b, 122, 128, and 124, respectively, which allows them to access the compliance information, processes and documentation and communicate with server 102/storage devices 104 as well as each other.

It is critical for an enterprise, e.g., franchisor 106, franchisees 108 and 112, and SMB's 116, to stay on top of compliance for all of its employees 111a-d and 117, respectively, across the globe. System 100 allows a plurality of compliance processes to be automatically configured, implemented and tracked. For example, system 100 can enable compliance processes that ensure all employees associated with a particular enterprise have up to date credentials—which would include employee permits and licenses, timely completion or refreshing of required training and certifications. The system 100 and the compliance processes implemented therein can also ensure all the required documents are read, acknowledged and/or signed by an employee or a certain class of employees. The class of employees can, e.g., be based on geography or by job classification.

The cloud based enterprise solution provided through system 100 allows management to monitor and enforce compliance requirements—in real time. Applications 120, 122, 124, 126 and 128 can provide an intuitive enterprise dashboard to ensure appropriate levels of access while protecting personal information.

System 100 enforces electronic versions of the enterprise compliance requirements (templates') throughout the enterprise's global network. There can be two types of ‘templates’: Business-level and employee level

Business templates: These are compliance requirements applicable to each location/store 110a-c and 114 within the enterprise. The location manager is responsible for confirming compliance with each of these requirements by logging into system 100, via application's 122 and providing e-signatures. These can, for example, be various location related documents that each location/store manager is supposed to read and acknowledge or e-sign. Or it can, for example, be a business license that needs to be tracked and renewed on a regular basis.

Employee templates: These are compliance requirements applicable to employees 111a-d within the enterprise. These templates are applied to individuals based on their roles, e.g., a service employee or a sale employee. The employees are responsible for confirming his/her compliance with each of these templates by logging into system 100 via application(s) 124 and providing his/her e-signature. Similar to business templates, these can be “read and acknowledge” or a document that is required to be “e-signed”.

Enterprise executives or operations team access server 102/storage devices 104 to create a template library using an easy-to-use template creation wizard. Employee-level templates, are applied based on role (e.g. ‘Service employee,’ ‘Sales employee,’ ‘front desk employee,’ ‘food handler’, ‘Driver’ etc.) and employment stage (e.g. ‘Prospect,’ ‘Hire,’ ‘Manage,’ ‘Retire’). These libraries only need to be created once during roll-out and can be added to or amended easily as needed.

The enterprise dashboard can be configured to show real-time compliance status across an enterprise. The dashboard is updated in real-time as employees from various locations complete their requirements. The enterprise can also see compliance status in further granularity: regional, location-level and department level. Importantly, no employee-level data is exposed, thereby maintaining privacy and eliminating any PII related risks. Once rolled-out, compliance is auto-enforced through real-time tracking. Templates can be configured to automatically re-enforce periodically (per quarter, every year, etc.) as per company policy. Additionally, any changes to the requirements are automatically deployed through the system for immediate action.

For the franchisor 106, system 100 can be configured to provide electronic versions of the franchisor's compliance requirements (‘franchisor templates’) to the franchise network through an online franchisor library that can be hosted by server 102/storage device 104. There are two types of ‘franchisor templates’: Business-level and employee level

Business templates: These are compliance requirements applicable to each franchisee business. The franchisee owner is responsible for confirming compliance with each of these requirements by logging into system 100 and providing e-signatures. These could be franchise policy updates that each franchisee is supposed to “read and acknowledge” or a document that each franchisee needs to “e-sign”!

Employee templates: These are compliance requirements applicable to employees 111a-d within the franchise network. The templates are applied to individuals based on their roles (e.g. an employee who is a ‘therapist’ is automatically enrolled against each of franchisor's ‘therapist’ templates). The employees 111a-d are responsible for confirming his/her compliance with each of these templates by logging into system 100 and providing his/her e-signature. Similar to business templates, these could be “read & acknowledge” or a document that is required to be “e-signed”!

Franchisors create the template library using an easy-to-use template creation wizard available through the UI included in application(s) 120. For employee-level templates, the franchisor 106 can create templates that are applicable based on role (e.g. ‘therapist,’ ‘front desk,’ ‘food handler’) and employment stage (e.g. ‘Prospect,’ ‘Hire,’ ‘Manage,’ ‘Retire’).

It should be noted that the templates can be created by system 100 in order to up to date with latest compliance requirements, e.g., certifications, timing, etc. The updates can be pulled in automatically from other databases and systems. The Franchisor can then customize the templates for its specific franchisees.

The libraries only need to be created once during roll-out and can be added to or amended easily as needed. Once rolled out, the franchisor dashboard will show real-time compliance status across the network. The dashboard is updated in real time as employees from various locations complete their requirements. The Franchisors can also see compliance status in further granularity: regional, location-level and department level. Importantly, no employee-level data is exposed to the Franchisor, thereby maintaining privacy and eliminating ‘joint employer’ risk. Once rolled-out, compliance is auto-enforced through real-time tracking. Templates can be configured to automatically re-enforce periodically (per quarter, every year, etc.) as per company policy. Additionally, any changes to the requirements are automatically deployed through the system for immediate action. The system 100 is designed for super-scaling using latest cloud based technology so it can scale with franchise growth.

For Franchisees 108/112 and SMB's 116 a location dashboard within applications 126a/b and 128, respectively, shows compliance summary for each business and provides further transparency on a location 110a-c and 114, department and employee 111a-d level. The applications 126a/b and 128 provide a secure, paperless database that comprehensively stores all compliance documents for each franchisee 108/112 and each location 110a-c and 114. Franchisees 126a/b and SMB's 116 have a clear indication of how many employees are compliant or not by department, location and business and can manage this compliance through a few simple clicks.

The applications 126a/b and 116 come pre-loaded with standard state and federal compliance requirements (‘templates’). These pre-loaded templates are provided for convenience (i.e. not required to be used) and can be customized to individual business needs. Each owner/business admin can also create his/her own custom library of compliance requirements (‘templates’) using an easy-to-use template creation wizard within applications 126a/b and 116.

In certain embodiments, franchisees 108a/b and 114 and SMB's 116 assign each template to a department (e.g. ‘therapist’) and employment stage (e.g. ‘Prospect,’ ‘Hire,’ ‘Manage,’ ‘Retire’). Next, they enter employees into the system and define their role and employment stage; currently compliant employees can be fast-tracked into the system. The applications 126a/b and 128 will then automatically assign the appropriate templates to individual employees.

In order to ensure compliance authenticity, each employee 111a-d and 117 receives his/her own login credentials to be used through applications 124 for their personal email accounts. The employee is responsible for logging into the system 100 and confirming his/her compliance through e-signatures.

The location dashboard within applications 126a/b and 128 shows only what the business owner needs to see, but allows the business owner to drill down to locations 110a-c, 114, and 116, departments, employees 111a-d and 117 or to actual documents. As soon as a task is completed, a compliance table is updated in real-time to show current compliance status for that employee and for the department/location/business.

The dashboard within applications 126a/b and 128 also provide a “heads up” for employees that are at-risk or have become non-compliant by sending an alert to the employee(s) and their respective managers.

System 100 maintains information privacy and security by restricting access based on employee responsibility. For example, a non-manager sees only his/her own documents and tasks; a department or location manager has access to the compliance status for the department or location, respectively, as well as the individual employees within each.

Once rolled-out, compliance is auto-enforced through real-time tracking. Templates can be configured to automatically re-enforce periodically (per quarter, every year, etc.) as per company policy. Additionally, any changes to the requirements are automatically deployed through the system for immediate action.

Thus, compliance monitoring is automated within system 100 at all levels. System 100 automatically monitors and enforces compliance and provides alerts when items are coming due. During rollout, each requirement (‘template’) will have a set of properties selected that define which employees and businesses it is applicable to (e.g. department, employee stage, etc.) as well as the length of compliance validity (e.g. twelve months). Once the template's properties are set, it will be automatically assigned to appropriate employees/businesses.

Thereafter, system 100 does all the work. It keeps track of who is compliant, at-risk and non-compliant, and raises alerts appropriately. If an existing compliance document is due for a periodic refresh, system 100 automatically assigns the task to the employee/business for re-completion.

System 100 also keeps track of supplemental document expiry (e.g. driver's license, therapist permit) and automatically alerts employees for an updated version to maintain compliance.

The various applications at the enterprise, business, location and employee level can provide a visual dashboard for real-time location compliance via a simple, click-n-go dashboard. The dashboard shows, e.g., franchisor 106 only what they need to see, but allows the location owner 108, 112, or 116 to drill down to departments, employees or to actual documents. The intuitive dashboard provides a “heads-up” for any possible upcoming items that need to be addressed to avoid non-compliance.

Through a few guided clicks, all outstanding tasks can be completed—including acknowledgements, initials & signatures. To ensure compliance, proactive alerts—without filling your inbox—provide gentle reminders to complete upcoming tasks to ensure compliance. Alerts are designed such that each entity can view the dashboard only as needed.

System 100 makes roll-out easy. At the franchisee level, it starts by creating locations and departments which takes minutes. And if system 100 knows which franchise you belong to, then the account may already have the standard departments used by the franchise.

The franchisee application 126a/b comes pre-loaded with standard state & federal compliance requirements (‘templates’). These pre-loaded templates are provided for convenience as example only (i.e. not required to be used). As good practice, franchisee 126a/b may want to customize some of the documents to avoid the need to add any additional information, thus keeping uniformity and removing any possibility of entry errors.

If the associated franchisor 106 is already set up in system 100, then franchisee 108/112 may already have library of all of the franchisor required documents & forms. If not, applications 126a/b can be used to create and add franchise templates to the library using our easy template creation tool.

Each owner/business admin can also create his/her own custom library of compliance requirements (‘templates’) using an easy-to-use template creation wizard within applications 126a/b and 128. A custom template can be created from an existing PDF documents.

As noted above, owners/business admins assign each template to a department (e.g. ‘therapist’) and employment stage (e.g. ‘Prospect,’ ‘Hire,’ ‘Manage,’ ‘Retire’). Next, they enter employees into the system and define their role and employment stage. System 100 will then automatically assign the appropriate templates to individual employees. Importantly, existing employees who are already compliant can be set-up using the “fast-track” feature (under 2 minutes per employee). For security purposes, this feature is available only for users that have Company Administrator privileges. You can always manually assign a particular template to a current employee.

Going forward, when a new candidate is hired, system 100 applies all the required compliance templates to the prospective employee based on the department and location. Until the employee completes a template (fill, sign, read, acknowledge, upload a document), the employee will not be moved into active stage.

All documents within system 100 can be E-signed and maintained digitally in the cloud. System 100 provides an easy to use template creation wizard for creation of custom library of documents—from existing legacy PDF or scanned documents. No need to re-create a document. Moreover, compliance changes can be deployed holistically across your business(es) in real-time, and raise alerts to ensure prompt compliance. System 100 can use legally binding e-Signatures that distributes all of your compliance items Paperless.

When a particular compliance requirement has changed, the business owner can simply create a new version of the existing template and ask system 10 to re-apply it to the appropriate employees/businesses (done under 2 minutes). The new template can be assigned to current employees or only for future employees only. No further action is needed as system 100 will raise alerts to complete the new templates.

Adding a new location or new business and applying existing templates is as easy as a few clicks. System 100 is designed for super-scaling using the latest cloud-based technology so it can scale with franchise growth. System 100 will automatically make existing libraries available to new locations and business and assign the appropriate templates to the new employees. The visual dashboard will update in real-time to reflect the new additions.

For Franchisors 106, as locations open up, all current active templates are automatically assigned to the franchisees 108 and 112 and location employees 111a-d with no additional action needed from the franchisor 106. The Franchisor dashboard within applications 120 will automatically update with compliance status of the newly added locations.

Appendix A is a set of screen shots that illustrate the set up process for a business administrator that would be implemented through applications 126a/b and 128.

Appendix B is a set of screen shots that illustrate a process for setting up templates for a business that would also be implemented through applications 126a/b and 128.

Appendix C is a set of screen shots that illustrate a process for an employee to set up their account through applications 124.

Appendix D is a set of screen shots illustrating various views included in the UI of application 124.

Appendix E is a set of screen shots illustrating various views included in the UI of application 120.

Appendix F is a set of screen shots illustrating the process of setting up templates for a franchisor 106.

Appendix G is a set of screen shots illustrating various views included in the UI of application 126a/b.

Appendix H is a set of screen shots illustrating various views included in the UI of application 128.

### Computer-Implemented Embodiment

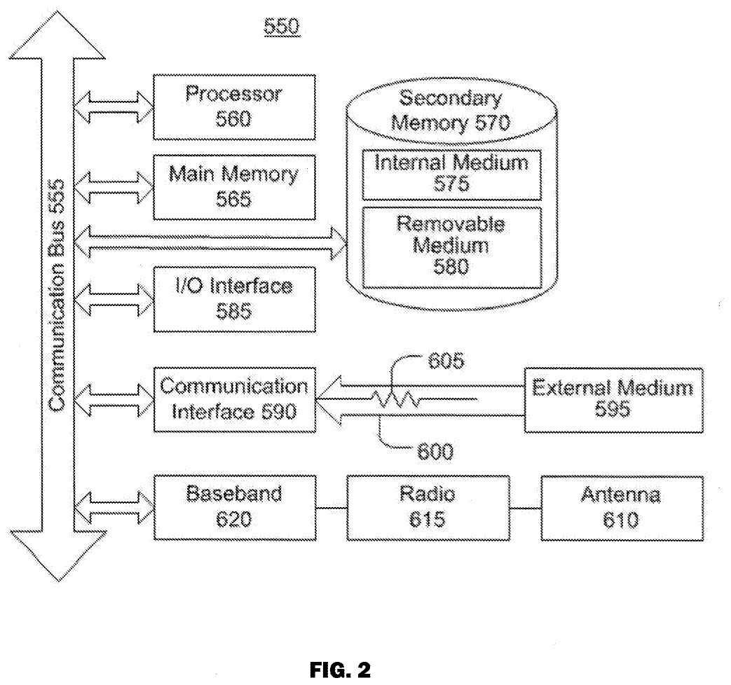

FIG. 2 is a block diagram illustrating an example wired or wireless system 550 that may be used in connection with various embodiments described herein. For example, the system 550 may be used as or in conjunction with a system 100 as previously described with respect to FIG. 1. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPM”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random-access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example, the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570 or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
one or more servers coupled with a plurality of storage devices configured to store a plurality of compliance templates for franchisors, franchisees, and small business owners, and a plurality of libraries created by one or more franchisors, one or more franchisees, and one or more small business owners;
a plurality of franchisor applications, franchisee applications, and small business applications, each application comprising a User Interface (U/I) and a template creation wizard;
a plurality of local devices configured to store the plurality of franchisor applications, franchisee applications, and small business applications comprising one or more processors configured to run the applications and automatically generate custom templates for each employee associated with each franchisee and small business owner based on the department, stage and location of the employee; and
a communication network coupled with the one or more servers, plurality of franchisor applications, franchisee applications, and small business applications and one or more storage devices and configured to allow the plurality of franchisor applications, franchisee applications, and small business applications to store the customized templates in one or more libraries associated with each of the franchisors, franchisees and small business owners.

2. The system of claim 1, wherein the one or more servers are further configured to associate documents in the library with each employee based on the customized template associated therewith.

3. The system of claim 2, further comprising one or more user processing devices configured to access documents via the communication network form the library and to confirm compliance with respect to the accessed documents.
